(19) United States
(12) Patent Application Publication
(10) Pub. No.: US 2004/0038076 A1
(43) Pub. Date: Feb. 26, 2004

(54) Poly (paraphenylenevinylene) derivatives and their use as electroluminescence materials

(76) Inventors: Willi Kreuder, Mainz (DE); Donald Lupo, Frankfurt (DE); Josef Salbeck, Kelkheim (DE); Hermann Schenk, Hofheim (DE); Thomas Stehlin, Kriftel (DE); Hans-Heinrich Horhold, Jena (DE); Andrea Lux, Jena (DE); Annett Teuschel, Jena (DE); Martina Wieduwilt, Jena (DE)

Correspondence Address: FROMMER LAWRENCE & HAUG, 745 FIFTH AVENUE- 10TH FL., NEW YORK, NY, 10151, US

(21) Appl. No.: 10/606,638

(22) Filed: Jun. 26, 2003

Related U.S. Application Data
(63) Continuation of application No. 09/795,795, filed on Feb. 28, 2001, now abandoned.
Application No. 09/795,795 is a continuation of application No. 08/817,328, filed on Mar. 27, 1997, now abandoned.

(30) Foreign Application Priority Data
Sep. 30, 1994 (DE) P 4435047.3
Feb. 17, 1995 (DE) 19505416.4

(51) Int. Cl. H05B 33/14; C09K 11/06

(52) U.S. Cl. 428/690; 428/917; 313/504; 257/40; 252/301.35; 528/220; 528/398; 526/256; 526/257; 526/258; 526/259; 526/265; 526/266

(57) ABSTRACT

Poly(paraphenylenevinylene) derivatives and their use as electroluminescence materials

Use of polymers containing structural units of the formula (I)

-[A¹-(A²)C═CH-A³-CH═C(A²)]- (I)

in which A¹, A² and A³ are identical or different mono- and/or polynuclear aryl and/or heteroaryl groups which are optionally linked via one or more bridges, preferably one bridge, and/or fused and can optionally be substituted, and in which in each case two bonds originate from A¹ and A³ and in each case one bond originates from A², as electroluminescence material.

The polymers of the formula (I) according to the invention are distinguished above all by a high stability, coupled with a high fluorescence quantum yield.

Poly(paraphenylenevinylene) derivatives and their use as electroluminescence materials

There is a high industrial demand for large-area solid-state light sources for a number of uses, chiefly in the field of display elements, screen technology and illumination. The requirements imposed on these light sources cannot currently be met with complete satisfaction by any of the existing technologies.

Electroluminescence (EL) materials and devices, such as light-emitting diodes (LED), have already been in use for some time as alternatives to conventional display and illumination elements, such as incandescent lamps, gas discharge lamps and non-luminous liquid-crystal display elements.

In addition to inorganic materials, low molecular weight organic electroluminescence materials and devices have also been known for about 30 years (cf., for example, U.S. Pat. No. 3,172,862). Until a short time ago, however, such devices were severely limited in their practical usefulness.

WO 90/13148 and EP-A 0 443 861 describe electroluminescence devices which comprise a film of a conjugated polymer as a light-emitting layer (semiconductor layer). Such devices offer numerous advantages, such as the possibility of producing large-area, flexible displays easily and inexpensively. In contrast to liquid-crystal displays, electroluminescence displays are luminous and therefore require no additional source of backlighting.

A typical device according to WO 90/13148 contains a light-emitting layer in the form of a thin, dense polymer film (semiconductor layer) which comprises at least one conjugated polymer. A first contact layer is in contact with a first surface, and a second contact layer is in contact with a further surface of the semiconductor layer. The polymer film of the semiconductor layer has a sufficiently low concentration of extrinsic charge carriers, so that when an electrical field is applied between the two contact layers, charge carriers are introduced into the semiconductor layer, one contact layer becoming positive with respect to the other, and the semiconductor layer emits radiation. The polymers used in such devices are generally conjugated. A conjugated polymer is understood as meaning a polymer which has a delocalized electron system along the main chain. The delocalized electron system imparts to the polymer semiconductor properties and gives it the possibility of transporting positive and/or negative charge carriers with a high mobility.

In WO 90/13148, poly(p-phenylenevinylene) (PPV) is used as the polymeric material for the light-emitting layer, and replacement of the phenyl group in such a material by a heterocyclic or a fused carbocyclic ring system is proposed. To achieve better stabilization with respect to the effects of oxygen, light and temperature, derivatives of PPV in which the hydrogens of the vinyl groups are substituted by phenyl groups have been synthesized (H. H. Hörhold et al., A novel approach to light emitting polyarylenes: Cyclization of poly(arylene vinylenes), International Conference on Science and Technology of Synthetic Metals ICSM 94, 24.-29.7.1994, Seoul, Korea; A. V. Vannikov, A. C. Saidov, Mendeleev Commun. 1993, 54). However, the fluorescence quantum yield is still unsatisfactory.

Monocyano-substituted PPV derivatives are also known (cf., for example, N. C. Greenham et al., Nature 1993, 365, 628).

Although good results have been achieved with these materials, the service life, photostability and stability toward air and water, for example, are still unsatisfactory. Furthermore, with the polymers known to date, it is scarcely possible to produce a blue or white emission.

Furthermore, since the development of electroluminescence materials, especially those based on polymers, cannot yet in any way be regarded as concluded, the manufacturers of illumination and display devices are interested in the most diverse electroluminescence materials for such devices.

This is because, inter alia, only the interaction of the electroluminescence materials with the other components of the devices allows conclusions regarding the quality, including that of the electroluminescence material.

The object of the present invention was therefore to provide novel electroluminescence materials which are suitable, when used in an illumination or display device, for improving the profile of properties of these devices.

It has now been found, surprisingly, that certain PPV derivatives monoaryl-substituted on the vinyl group are particularly suitable for use as electroluminescence materials.

The invention therefore relates to the use of polymers containing structural units of the formula (I)

-[A¹-(A²)C═CH-A³-CH═C(A²)]- (I)

in which A¹, A² and A³ are identical or different mono- and/or polynuclear aryl and/or heteroaryl groups which are optionally linked via one or more bridges, preferably one bridge, and/or fused and can optionally be substituted, and in which in each case two bonds originate from A¹ and A³ and in each case one bond originates from A² as electroluminescence materials.

The polymers used according to the invention are distinguished above all by a high stability, coupled with a high fluorescence quantum yield.

Substances which can be used as the active layer in an electroluminescence device are regarded as electroluminescence material in the context of the invention. Active layer means that, when an electrical field is applied, this layer is capable of radiating light (light-emitting layer) and/or that it improves the injection and/or transportation of the positive and/or negative charges (charge injection or charge transportation layer).

The invention therefore also relates to an electroluminescence material comprising one or more polymers containing structural units of the formula (I).

In the context of the invention, polymer means a compound whose electroluminescence spectrum remains essentially the same when further structural units are added.

The polymers used according to the invention in general have 2 to 1000, preferably 3 to 500, particularly preferably 4 to 300, structural units.

Preferred polymers are furthermore those in which the symbols in the formula (I) have the following meaning:

A¹, A³: are identical or different

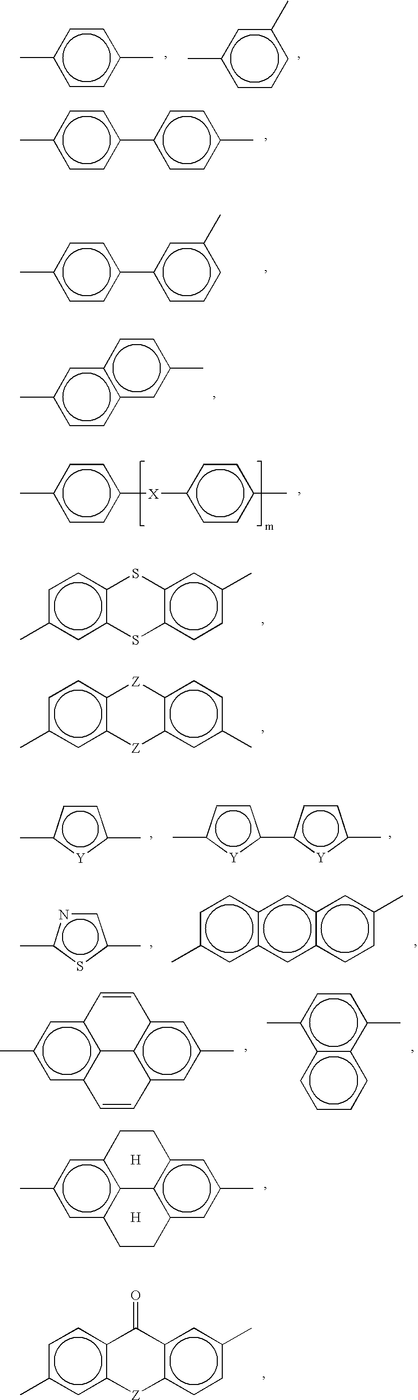

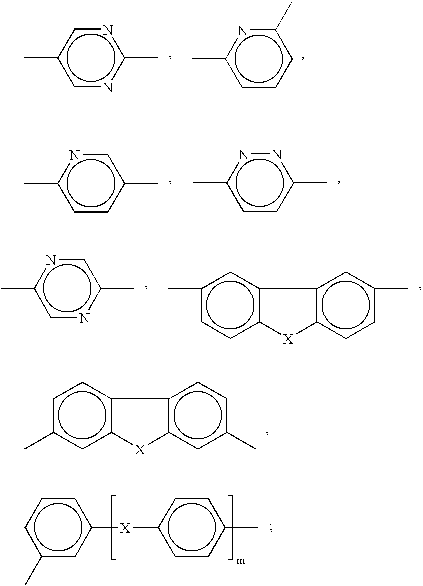

where m=1 to 20, preferably 1, 2 or 3, particularly preferably 1, preferably only for A³ is m>1;

A²: has the same meanings as A¹ and A³ and is identical to or different from A¹ and A³, of the two possible bonding sites to the polymer, in each case only one being realized;

A¹, A² and A³ can be substituted here independently of one another by one or more radicals R;

X: a single bond, —O—, —S—, —SO—, —SO₂—, —CRR—, —CR═CR—, —CH₂—CH₂— or —CHR—CHR—;

Y: —O—, —S— or —NR′—;

Z: identical or different —O— or —S—;

R: identical or different at each occurrence and being H or an alkyl group having 1 to 12 carbon atoms, it also being possible for one or two non-adjacent CH₂ groups to be replaced by —O—, —S—, —CO—, —CO—O—, —O—OC— or —Si(CH₃)₂—, —CF₃, -Ph, —O-Ph, —S-Ph, —SO-Ph, —SO₂-Ph, F, Cl, Br, I or —CN;

R′: H, an alkyl group having 1 to 12 carbon atoms or -Ph.

The symbols in the formula (I) particularly preferably have the following meanings:

A¹, A³: are identical or different

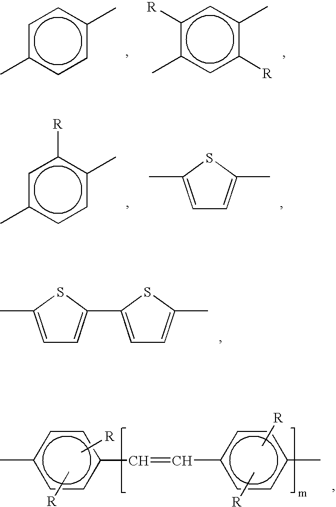

where m=1 to 20, preferably 1, 2 or 3, particularly preferably 1, R is preferably H, preferably only for A³ is m>1;

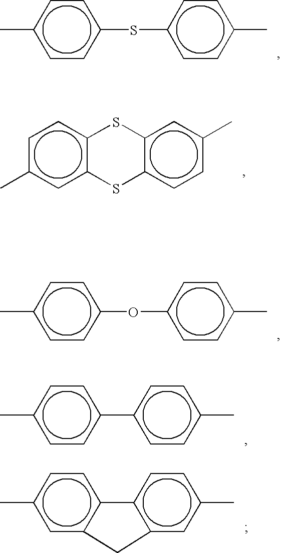

A² has the same meanings as A¹ and A³ and is identical to or different from A¹ and A³, of the two possible bonding sites to the polymer, in each case only one being realized, or is

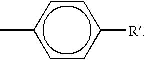

The following groups of polymers containing structural units of the formula (I) are especially preferred:

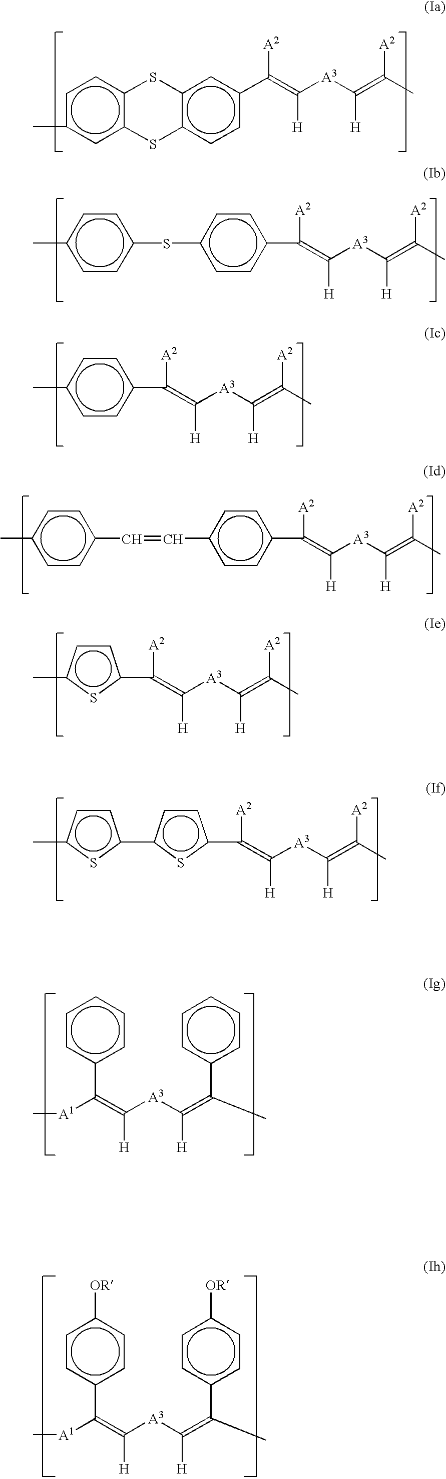

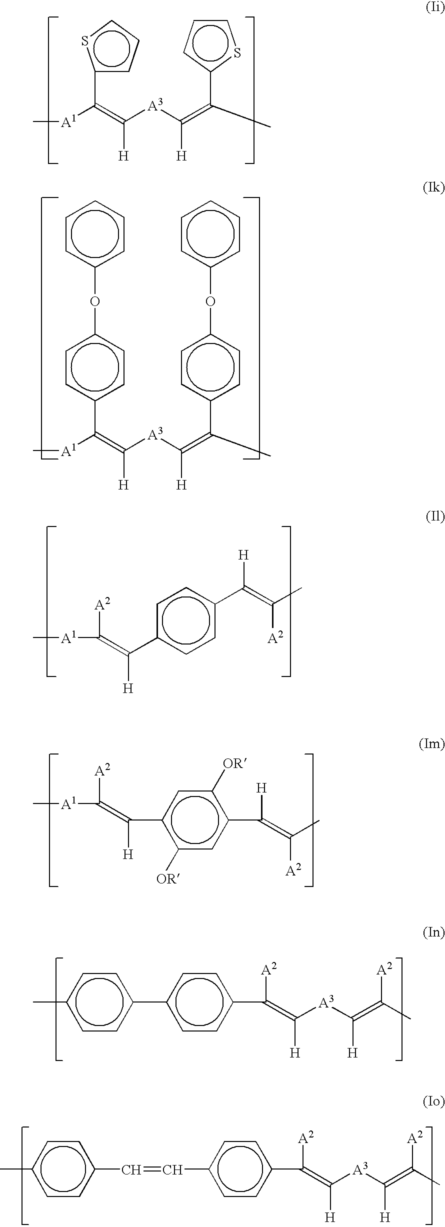

in which A¹, A², A³ and R′ have the meanings given in formula (I).

The polymers containing structural units of the formula (I) are known in some cases and novel in some cases.

The invention therefore also relates to polymers containing structural units of the formula (I) in which the symbols have the abovementioned meanings, with the proviso that one of the groups A¹, A² and A³ must be a heterocyclic radical.

The polymers according to the invention or used according to the invention are expediently prepared by condensation of diketones of the formula (II)

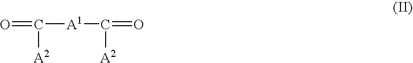

in which A¹ and A² have the meanings given in formula (I),

with organophosphorus compounds of the formula (III)

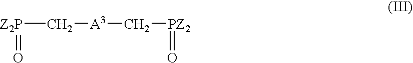

in which A³ has the meanings given in the formula (I) and Z is alkoxy, preferably ethoxy, or aryl radicals, preferably phenyl.

The condensation is carried out by the action of a basic condensing agent, preferably potassium tert-butylate.

The polycondensation is expediently carried out by initially introducing an equimolar mixture of the starting components (I) and (III) in a solvent into the reaction vessel and introducing preferably at least molar amounts of condensing agent, in solution or suspension, under an inert gas atmosphere and while stirring.

According to another working variant, the condensing agent can also be initially introduced into the reaction vessel in a solvent by itself or with the diketone, and the bisphosphorus component can be added. Solvents which are preferably used are benzene, toluene, xylene or dimethylformamide, the reaction temperature is preferably 60 to 120° C. and the reaction time is 5 to 20 hours. The reactions take place virtually quantitatively.

Working up can be carried out by adding water and if appropriate an acid, such as acetic acid, and separating off the organic reaction phases. The resulting condensation products can be extracted for purification, for example with alcohols or acetic acid, or precipitated from a solvent in a non-solvent.

This preparation process is described generally, for example, in DD 84 272, Hörhold, H. -H.: Z. Chem. 12, 41-52 (1972).; Hörhold, H. -H.; Bergmann, R.; Gottschaldt, J.; Drefahl, G.: Acta Chim. Acad. Sci. Hung. 81, 239-251; Hörhold, H. -H.; Bergmann, R.: Advances in the Chemistry of Thermally Stable Polymers, Warsaw, Polish Scientific Publishers, 29-48 (1977); Hörhold, H. -H.; Helbig, M.: Makromol. Chem., Macromol. Symp. 12, 229-258 (1987) and Hörhold, H. -H.; Helbig, M.; Raabe, D.; Opfermann, J.; Scherf, U.; Stockmann, R.; Weib, D.: Z. Chem. 27, 126 (1987)

The starting compounds (II) and (III) are prepared by methods known per se from the literature, such as are described in standard works on organic synthesis, for example Houben-Weyl, Methoden der Organischen Chemie [Methods of organic Chemistry], Georg-Thieme-Verlag, Stuttgart.

The preparation is carried out here under reaction conditions which are known and suitable for the reactions mentioned. Variants which are known per se and are not mentioned here in more detail can also be used.

The bis(diphenylphosphine oxides) or bis(phosphonic acid esters) required as condensation components are readily accessible, for example, from the corresponding bis(halomethyl) compounds with diphenylphosphinous acid ethyl ester (C₆H₅)₂P—O—C₂H₅ or with triethyl phosphite, using the Michaelis-Arbusov reaction.

The synthesis of aromatic diketones can be carried out, for example, by the known Friedel-Crafts reaction, with AlCl₃ as the catalyst, as shown by way of example in equation 1 with the aid of three specific compounds.

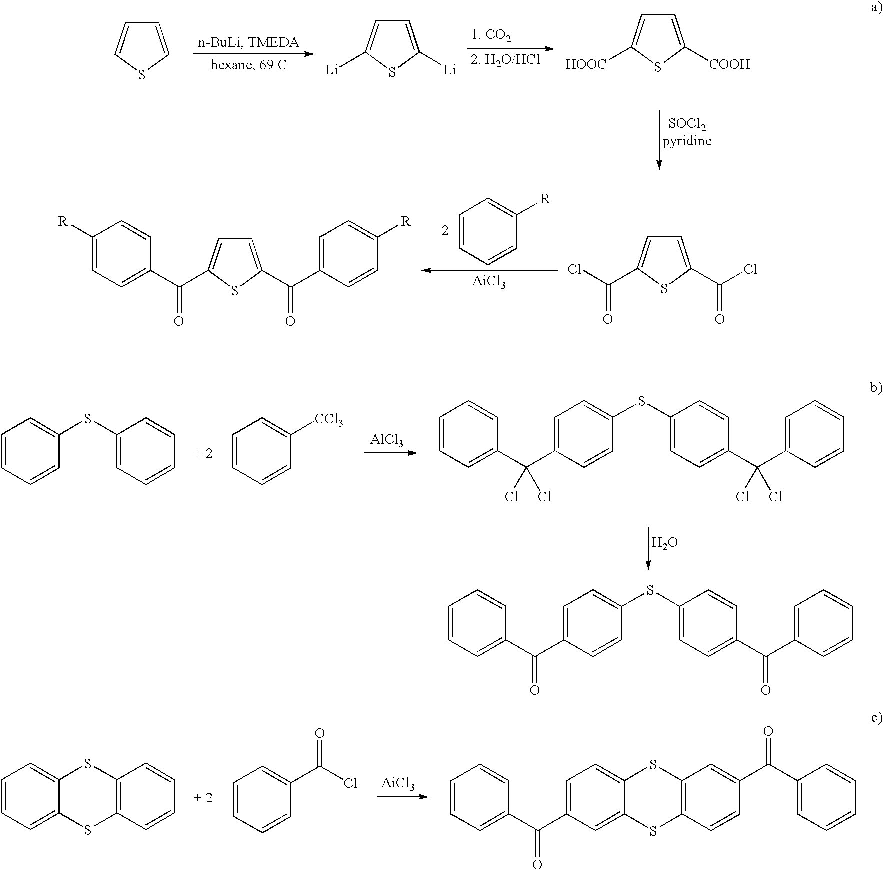

Another variant is the Grignard reaction of arylmagnesium bromides with dicyanoarylene, shown by way of example in equation 2:

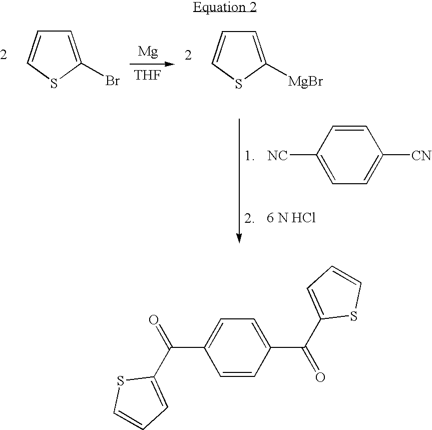

E/Z isomers may be formed in the Horner reaction. Isomers also result from the possible position of the two double bonds relative to one another (trans-trans-anti, trans-trans-syn, cis-trans-anti, cis-trans-syn, cis-cis-anti, cis-cis-syn), and the invention relates to all of them.

By employing different diketones and/or bisphosphonates, copolymers which contain different structural units of the formula (I) are obtained in a simple manner. The radicals R² in the formula (I) in such copolymers can optionally also have different meanings.

Alternatively, smaller groups of polymers containing structural units of the formula (I) in which A¹ is -A′-A′-, in which A′ is an electron rich aromatic, can also be polymerized oxidatively (for example with FeCl₃, see, inter alia,. P. Kovacic, N. B. Jones, Chem. Ber. 1987, 87, 357 to 379; M. Weda, T. Abe, H. Awano, Macromolecules 1992, 25, 5125) or electrochemically (see, for example, N. Saito, T. Kanbara, T. Sato, T. Yamamoto, Polym. Bull. 1993, 30, 285).

To be used as electroluminescence materials, the polymers according to the invention are in general applied in the form of a film to a substrate by known methods with which the expert is familiar, such as dipping, casting or spin-coating.

The invention therefore also relates to a process for the production of an electroluminescence material, which comprises

a) subjecting an organophosphorus compound of the formula (III)

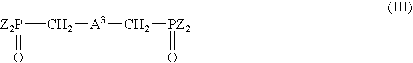

to a condensation reaction with a diketone of the formula (II)

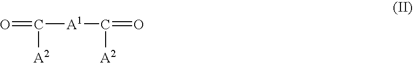

under the action of a basic condensing agent, to give a polymer containing structural units of the formula (I)

-[A¹-(A²)C═CH-A³-CH═C(A²)]- (I)

in which A¹, A² and A³ are identical or different mono- and/or polynuclear aryl and/or heteroaryl groups which are optionally linked via one or more bridges, preferably one bridge, and/or condensed and can optionally be substituted, and in which in each case two bonds originate from A¹ and A³ and in each case one bond originates from A²; and

b) applying the resulting polymer in the form of a film to a substrate.

The invention furthermore relates to an electroluminescence device having one or more active layers, at least one of these active layers comprising one or more polymers according to the invention. The active layer can be, for example, a light-emitting layer and/or a transportation layer and/or a charge injection layer.

The general structure of such electroluminescence devices is described, for example, in U.S. Pat. No. 4,539,507 and U.S. Pat. No. 5,151,629. Electroluminescence devices comprising polymers are described, for example, in WO 90/13148 or EP-A 0443861.

They usually comprise an electroluminescent layer between a cathode and an anode, at least one of the electrodes being transparent. An electron injection and/or electron transportation layer can additionally be introduced between the electroluminescent layer and the cathode, and/or a hole injection and/or hole transportation layer can be introduced between the electroluminescent layer and the anode, Ca, Mg, Al, In or Mg/Ag, for example, can be used as the cathode. Au or ITO (indium oxide/tin oxide) on a transparent substrate, for example of glass or a transparent polymer, can be used, for example, as the anode.

During operation, the cathode is placed at a negative potential with respect to the anode. In this arrangement, electrons are injected from the cathode into the electron injection layer/electron transportation layer or directly into the light-emitting layer. At the same time, holes are injected from the anode into the hole injection layer/hole transportation layer or directly into the light-emitting layer.

Under the influence of the voltage applied, the charge carriers injected move toward one another through the active layers. This leads to electron/hole pairs at the boundary between the charge transportation layer and the light-emitting layer or within the light-emitting layer, and these recombine, emitting light.

The color of the light emitted can be varied by way of the compound used as the light-emitting layer.

Electroluminescence devices are used, for example, as luminous display elements, such as control lamps, alpha-numeric displays and information signs, and in opto-electronic couplers.

The invention is illustrated in more detail by the examples, without wishing to limit it thereby.

### EXAMPLES

The abbreviations have the following meanings:

Tg: Glass transition temperature, measured by means of differential scanning calorimetry (DSC)

Mₙ: Number average molecular weight

VPO: Vapor pressure osmometry (see, for example, Cherdron, Kern, Braun, Praktikum der Makromolekularen Chemie. [Practical Macromolecular Chemistry])

A. Starting Compounds

2,7-Dibenzoylthianthrene

A solution of 21.63 g of thianthrene (0.1 mol) and 46.91 g of benzotrichloride (0.24 mol) in 75 ml of 1,2-dichloroethane is added dropwise to a stirred suspension of 33.33 g of AlCl₃ (0.25 mol) in 150 ml of 1,2-dichloroethane in a 500 ml multi-necked flask with a Claisen attachment, stirrer, reflux condenser and internal thermometer, while cooling with an ice/sodium chloride mixture, such that the temperature does not rise above 5° C. The mixture is then stirred at room temperature for about 6 hours and left to stand overnight. To bring the reaction to completion, the mixture is stirred at 35° C. for a further 3 hours and then hydrolyzed with ice/HCl. The tetrachloride formed is hydrolyzed under reflux with 200 ml of glacial acetic acid and 15 ml of water for about 10 hours to give the diketone. The crude product is taken up in toluene and the mixture is dried and concentrated. The residue is chromatographed in portions of 3 to 4 g with 130 g of silica gel 60 R each time (eluent:toluene), a total of 0.4 g of monoketone also being isolated. The 2,7-dibenzoylthianthrene is then recrystallized from toluene. This gives pale yellow crystals, melting point 195° C.

Yield: 28.3 g = 67% of theory

| C₂₆H₁₆O₂S₂ | calculated | C 73.56 | H 3.80 | S 15.10 |
|---|---|---|---|---|
| (424.508) | found | C 73.66 | H 3.82 | S 15.19 |

4,4-Dibenzoyldiphenyl sulfide

26.5 g of AlCl₃ (0.2.mol) are initially introduced into 100 ml of 1,2-dichloroethane in a 250 ml multi-necked flask with a stirrer, reflux condenser and dropping funnel. A solution of 14.0 g of diphenyl sulfide (0.075 mol) and 22.5 g of benzoyl chloride in 35 ml of 1,2-dichloroethane is added dropwise to this suspension, while stirring and cooling with an ice/sodium chloride mixture, such that the temperature does not exceed 5° C. Stirring is then continued at room temperature for 6 hours and the mixture is left to stand overnight. The ice-cold reaction mixture is poured onto an ice/HCl mixture for hydrolysis. The organic phase is separated off and washed twice with dilute NaOH and several times with distilled water. The solvent is then removed by means of steam distillation and the crude product is recrystallized twice from dimethylformamide/ethanol=1:1. This gives white, shiny platelets, melting point 173° C.

Yield: 15.9 g = 57% of theory

| C₂₆H₁₈O₂S | calculated | C 79.19 | H 4.57 | S 8.12 |
|---|---|---|---|---|
| (394.462) | found | C 79.39 | H 4.60 | S 8.11 |

Hydroquinone dioctyl ether

20 g of hydroquinone (0.18 mol) are initially introduced into 250 ml of dimethylformamide in a 500 ml multi-necked flask with a stirrer, reflux condenser and dropping funnel, and 8.6 g of sodium hydride (0.36 mol) are cautiously added. The mixture is heated under reflux, while stirring, until the evolution of hydrogen has ended and n-octyl bromide is added dropwise in the course of 30 minutes. The reaction solution is stirred at 130° C. for 2 hours and left to stand overnight. The reaction mixture is heated to 60° C., the sediment is filtered off and the filtrate is concentrated. Recrystallization of the residue twice from methanol gives white flakes, melting point 56° C.

Yield: 48.3 g = 80% of theory

| C₂₂H₃₈O₂ | calculated | C 79.05 | H 11.38 |
|---|---|---|---|
| (334.23) | found | C 79.42 | H 11.33 |

2,5-Dioctyloxy-1,4-bis(bromomethyl)benzene

22 g of hydroquinone dioctyl ether (0.066 mol), 27.8 g of paraformaldehyde (0.927 mol), 34.7 g of sodium bromide (0.337 mol) and 400 ml of glacial acetic acid are heated, while stirring, to 80° C. in a 1 l multi-necked flask with a stirrer, reflux condenser and dropping funnel, and a mixture of 35 ml of concentrated sulfuric acid and 45 ml of glacial acetic acid is added dropwise in the course of one hour. The mixture is stirred at 80° C. for 5 hours and then cooled to room temperature. The solid which has separated out is filtered off with suction and washed several times with water. The organic filtrate is poured carefully into 500 ml of distilled water and the mixture is extracted several times with methylene chloride. After the extract has be n combined with the solid, the mixture is dried over CaCl₂ and the solvent is then distilled off. Recrystallization of the reside from hexane gives white matted crystals, melting point 83° C.

Yield: 26.6 g = 77% of theory

| C₂₄H₄₀Br₂O₂ | calculated | C 55.40 | H 7.60 | Br 30.72 |
|---|---|---|---|---|
| (520.366) | found | C 55.56 | H 7.69 | Br 30.08 |

2,5-Dioctyloxy-1,4-xylylene-bis(diethyl phosphonate)

20.81 g of 2,5-dioctyloxy-1,4-bis(bromomethyl)benzene (0.04 mol) and 13.29 g of triethyl phosphite (0.08 mol) are heated to 130° C. in a 250 ml two-necked flask with a magnetic stirrer and distillation bridge, the ethyl bromide formed being distilled off. The mixture is heated to 190° C. in the course of 1 hour and stirred at this temperature for a further 3 hours. A vacuum is applied for a further 3.0 minutes at this temperature to remove residual triethyl phosphite. After cooling, the residue solidifies to a waxy mass, which is recrystallized from petroleum ether. This gives fine white crystals, melting point 41° C.

Yield: 20.8 g = 82% of theory

| C₃₂H₆₀O₈P₂ | calculated | C 60.55 | H 9.53 |
|---|---|---|---|
| (634.745) | found | C 60.50 | H 9.57 |

B. Polymers

### Example 1

Poly[2,5-dioctyloxy-1,4-phenylene-2-phenyl-vinylene-2,5-thienylene-1-phenylvinylene]

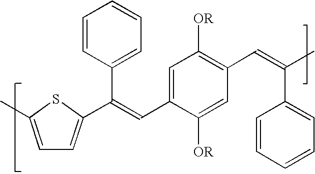

2.046 g of 2,5-dibenzoylthiophene (0.007 mol) and 4.443 g of 2,5-dioctyloxy-1,4-xylylene-bis(diethyl phosphonate) (0.007 mol) in 150 ml of toluene, dried over Na/benzophenone, are initially introduced into a 350 ml multi-necked flask which has an internal thermometer, stirrer, reflux condenser and dropping funnel and is flushed with argon, and are heated to 40 to 60° C. until the starting substances have dissolved completely. 3.14 g of potassium tert-butylate (0.028 mol) are now added and the reaction mixture is heated under reflux for 20 hours. It is then allowed to cool to room temperature and the mixture is hydrolyzed with 100 ml of 10% strength acetic acid, while stirring moderately (prevention of the formation of an emulsion). The toluene phase is separated off, washed three times with distilled water and concentrated. For drying, the residue is taken up in benzene and the mixture is heated, using a water separator. After the salts which have precipitated out have been filtered off, the solution is concentrated to 30 to 40 ml and the product is precipitated in methanol. For purification of the sample, the operation is repeated once. The residual solid is filtered off with suction, washed with methanol and dried in vacuo (0.01 mm) for 20 hours. This gives a dark red, low-melting: powder, Tg=33° C.

Yield: 3.32 g = 77% of theory, Mₙ (VPO) = 4700 g/mol⁻¹

| C₄₂H₅₀O₂ S | calculated | C 81.50 | H 8.14 | S 5.18 |
|---|---|---|---|---|
| (618.878) | found | C 77.88 | H 8.35 | S 5.11 |

### Example 2

Poly[2,5-dioctyloxy-1,4-phenylene-2-thienyl-vinylene-1,4-phenylene-1-thienylvinylene]

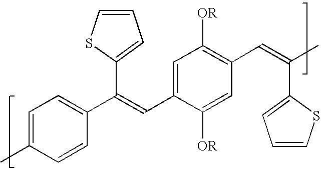

Batch: 2.08.9 g of 1,4-bis(2-thienoyl)benzene (0.007 mol).

4.443 g of 2,5-dioctyloxy-1,4-xylylene-bis(diethyl phosphonate) (0.007 mol)

3.14 g of potassium tert-butylate (0.028 mol)

150 ml of toluene

Procedure: analogously to Example 1

An ochre-colored, low-melting powder is isolated, Tg=58° C.

Yield: 2.1 g = 48% of theory, Mₙ (VPO) = 12900 g/mol⁻¹

| C₄₀H₄₈O₂S₂ | calculated | C 76.88 | H 7.74 | S 10.26 |
|---|---|---|---|---|
| (624.902) | found | C 75.09 | H 7.85 | S 9.06 |

### Example 3

Poly[2,5-dioctyloxy-1,4-phenylene-2-phenylvinylene-1,4-phenylene-thio-1,4-phenylene-1-phenylvinylene]

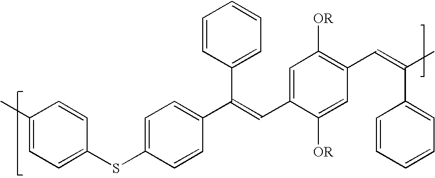

Batch: 2.761 g of 4,4′-dibenzoyldiphenyl sulfide (0.007 mol)

4.443 g of 2,5-dioctyloxy-1,4-xylylene-bis(diethyl phosphonate) (0.007 mol)

3.14 g of potassium tert-butylate (0.028 mol)

150 ml of toluene

Procedure: analogously to Example 1

This gives a luminous yellow, low-melting powder, Tg=54° C.

Yield: 3.69 g = 73% of theory, Mₙ (VPO) = 6300 g/mol⁻¹

| C₅₀H₅₆O₂S | calculated | C 83.29 | H 7.83 | S 4.45 |
|---|---|---|---|---|
| (721.006) | found | C 81.52 | H 7.62 | S 4.12 |

### Example 4

Poly[2, 5-dioctyloxy-1,4-phenylene-2-phenylvinylene-2,7-thianthrenylene-1-phenylvinylene]

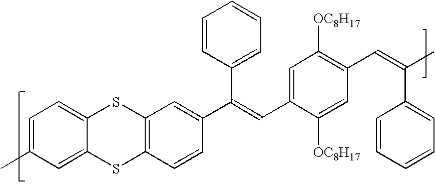

Batch: 2.972 g of 2,7-dibenzoylthianthrene (0.007 mol)

4.443 g of 2,5-dioctyloxy-1,4-xylylene-bis(diethyl phosphonate)

3.14 g of potassium tert-butylate (0.028 mol)

150 ml of toluene

Procedure: analogously to Example 1

This gives a luminous yellow powder, Tg=78° C.

Yield: 3.80 g = 72% of theory, Mₙ (VPO) = 6500 g/mol⁻¹

| C₅₀H₅₄O₂S₂ | calculated | C 79.95 | H 7.25 | S 8.54 |
|---|---|---|---|---|
| (751.050) | found | C 79.32 | H 7.19 | S 8.23 |

### Example 5

Poly[1,4-phenylene-2-phenylvinylene-2,5-thienylene-1-phenylvinylene]

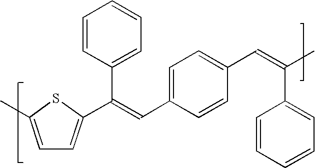

Batch: 5.846 g of 2,5-dibenzoylthiophene (0.02 mol) 7.566 g of. 1,4-xylylene-bis(diethyl phosphonate) (0.02 mol)

9.78 g of potassium tert-butylate (0.08 mol)

200 ml of toluene

Procedure: analogously to Example 1

After hydrolysis of the reaction mixture, an insoluble content remained, which was dried, powdered and then extracted with hot methanol. The IR spectrum was completely identical to that of the soluble content. The usual procedure was followed with the soluble content, but the substance was isolated by precipitation in hexane. Fractionation was carried out by precipitation of the compound from methylene chloride in methanol. Extraction of the resulting solid with methanol and drying at 60° C. in vacuo (0.05 mm Hg, 20 hours) gives an orange-colored powder, Tg=141° C.

Yield: soluble content: 3.32 g = 46% of theory, Mₙ (VPO) = 2300 g/mol⁻¹
insoluble content: 1.38 g = 19% of theory

| C₂₅H₁₈S | calculated | C 86.15 | H 5.01 | S 8.84 |
|---|---|---|---|---|
| (362.464) | found | C 82.26 | H 5.36 | S 8.51 |

(soluble content)

### Example 6

Poly[1,4-phenylene-2-(4-methoxyphenyl)vinylene-2,5-thienylene-1-(4-methoxyphenyl)vinylene]

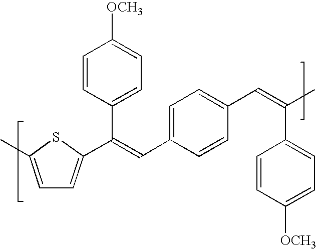

Batch: 3.524 g of 2,5-bis(4-methoxybenzoyl)thiophene (0.01 mol)

3.783 g of 1,4-xylylene-bis(diethyl phosphonate) (0.01 mol)

4.89 g of potassium tert-butylate (0.04 mol) 150 ml of toluene

Procedure: analogously to Example 1 (soluble content)

This gives an orange-red powder, Tg=147° C.

Yield: 2.65 g = 63% of theory, Mₙ (VPO) = 4800 g/mol⁻¹

| C₂₈H₂₂O₂S | calculated | C 79.59 | H 5.25 | S 7.59 |
|---|---|---|---|---|
| (422.514) | found | C 78.30 | H 5.13 | S 7.62 |

### Example 7

Poly[1,4-phenylene-2-(4-phenoxyphenyl)vinylene-2,5-thienylene-1-(4-phenoxyphenyl)vinylene]

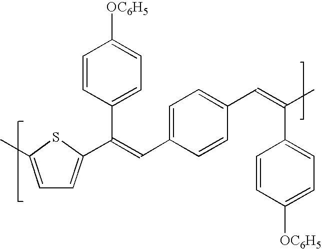

Batch: 4.765 g of 2,5-bis(4-phenoxybenzoyl)thiophene (0.01 mol)

3.783 g of 1,4-xylylene-bis(diethyl phosphonate) (0.01 mol)

4.89 g of potassium tert-butylate (0.04 mol) 150 ml of toluene

Procedure: analogously to Example 1, but fractionation of the sample was carried out by precipitation in acetone.

This gives an orange-red powder, Tg=133° C.

Yield: 3.01 g = 55% of theory, Mₙ (VPO) = 11300 g/mol⁻¹

| C₃₈H₂₆O₂S | calculated | C 83.49 | H 4.79 | S 5.86 |
|---|---|---|---|---|
| (546.646) | found | C 82.09 | H 5.01 | S 5.72 |

### Example 8

Poly[2,5-dioctyloxy-1,4-phenylene-2-phenylvinylene-2,2′-bithienylene-1-phenylvinylene]

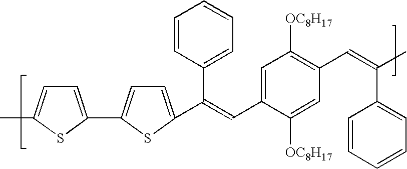

A solution of 0.75 g of 2,5-dioctyloxy-1,4-bis[2-phenyl-2-(2-thienyl)ethenyl]benzene 6b (1.06 mmol) is slowly added dropwise to a stirred suspension of 3 g of FeCl₃.6H₂O (11.1mmol) in 250 ml of CH₂Cl₂. The solution immediately becomes deep blue in color. When the addition has ended, the mixture is stirred at room temperature for 3 days. The mixture is then hydrolyzed with dilute hydrochloric acid (150 ml of H₂O, 5 ml of concentrated HCl), and the methylene chloride phase is washed several times with distilled water until neutral and concentrated. Thereafter, for drying, the residue is taken up in 150 ml of benzene and heated using a water separator. The solution is concentrated to about 100 ml and filtered over 0.5 g of silica gel 60 H. Centrifugation and filtration give a clear solution, which is concentrated to about 15 ml and precipitated in methanol. For purification, the precipitation operation is repeated once. The resulting powder is dried in vacuo (0.05 mm Hg) at 60° C. for 20 hours.

Yield: 0.59 g = 80% of theory, Mₙ (VPO) = 25000 g/mol⁻¹

| C₄₆H₅₄O₂S₂ | calculated | C 78.81 | H 7.48 | S 9.15 |
|---|---|---|---|---|
| (700.996) | found | C 78.57 | H 7.64 | S 9.21 |

### Example 9

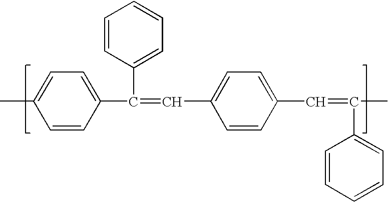

A solution of 0.005 mol of 1,4-bis(benzoyl)benzene (terephthalophenone) and 0.005 mol of p-xylylene-bis-(phosphonic acid diethyl ester) in 75 ml of dry toluene is added dropwise to a solution of 0.02 mol of potassium tert-butylate in 75 ml of dry toluene at a temperature of 110° C., while stirring and under an inert gas. After a reaction time of 10 hours, the mixture is hydrolyzed with dilute acetic acid and worked up analogously to Example 1.

The yield after purification is 75%.

Tg=198.5° C., Mₙ=62:40 g/mol (VPO) after reprecipitation.

### Example 10

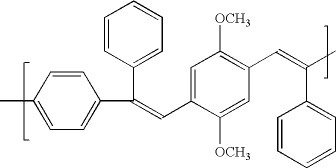

0.01 mol of 2,5-dimethoxy-p-xylylene-bis(diphenylphosphine oxide) in 150 ml of dry toluene is added dropwise to 0.01 mol of terephthalophenone and 0.04 mol of potassium tert-butylate in 100 ml of dry toluene at 100° C., while stirring and under an inert gas. The reaction time and working up are as in Example 1.

This gives a chrome-yellow crude product in a 95% yield, which, after extraction, melts in the range from 225 to 240° C. and shows an intense yellow-green fluorescence in solution: Mₙ (VPO)=5100 g/mol, Tg=195° C.

### Example 11

Poly[1,4-phenylene-2-phenylvinylene-4,4′-biphenylene-1-phenylvinylene]

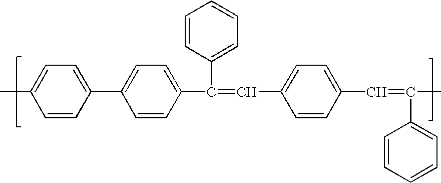

The preparation is carried out analogously to Example 1. Mₙ (VPO): 3650; Tg: 220° C.

### Example 12

Poly[2,5-dimethoxy-1,4-phenylene-2-(4-methoxyphenyl)vinylene-1,4-phenylene-1-(4-methoxyphenyl)vinylene]

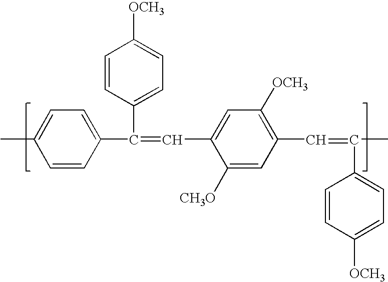

The preparation is carried out analogously to Example 1.

Mₙ (VPO): 8750; Tg: 179.5° C.

### Example 13

Poly[1,4-phenylenevinylene-1,4-phenylene-2-(4-phenoxyphenyl)-1,4-phenylene-1-(4-phenoxyphenyl)vinylene]

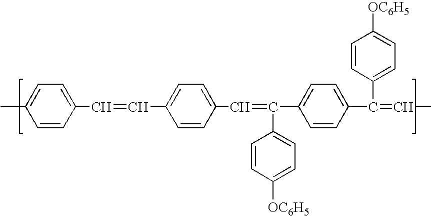

The preparation is carried out analogously to Example 1.

Mₙ (VPO): 4780; Tg: 152° C.

### Example 14

Poly(2,5-dimethoxy-1,4-phenylene-[2-(4-fluorophenyl)-1,2-vinylene]-1,4-phenylene-[1-(4-fluorophenyl)-1,2-vinylene])

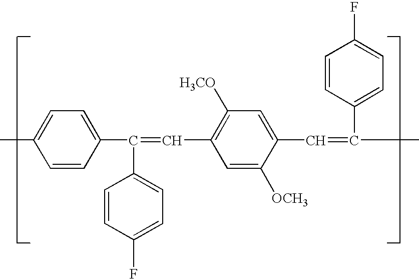

| | | |
|---|---|---|
| 1,4-Bis-4-(fluorobenzoyl)benzene | 3.242 g | (10 mmol) |
| 2,5-dimethoxy-p-xylylene-bis(di- | 4.523 g | (10.3 mmol) |
| ethyl phosphonate) | | |
| Potassium tert-butylate | 3.6 g | (32 mmol) |

The diketone and the diphosphonate are dissolved in about 100 to 150 ml of toluene freshly distilled off from Na/benzophenone in a dry 500 ml multi-necked flask which has a stirrer and reflux condenser and is flushed with argon, the reaction mixture being heated to 100 to 110° C. The potassium tert-butylate is then carefully added under argon, during which the reaction mixture foams and becomes red-green in color. After the addition of the potassium tert-butylate, the mixture is stirred at a bath temperature of 120 to 130° C. for 8 hours. At the end of the reaction time, the batch is hydrolyzed with 100 ml of 10% strength acetic acid. It is left to stand overnight and the phases are then separated. The organic phase is washed once to twice with water and the aqueous phase is extracted by stirring several times with toluene. The organic phases are then combined and concentrated to dryness on a rotary evaporator. The residue is taken up in 250 to 300 ml of benzene and the mixture is boiled for one day, using a water separator. The solution is then filtered off from the residue which remains and is concentrated to 20-30 ml on a rotary evaporator until the solution can be precipitated in 400 ml of methanol. The luminous yellow precipitate is filtered off with suction and dried in vacuo at 120° C.

The crude polymer yield is 3.75 g (83% of theory) and the Mₙ (GPC) is 6910 g mol⁻¹. The polymer is then extracted with methanol. The glass transition point T_{g} is 202° C.

| Mₙ (VPO): | 13,800 g mol⁻¹ |
|---|---|
| Mₙ (GPC): | 11,100 g mol⁻¹ |
| M_{w} (GPC): | 92,200 g mol⁻¹ |
| M_{w}/Mₙ: | 8,334 |

C₃₀H₂₂F₂O₂[452.48.] calc.: C: 79.62 H: 4.90

found: C: 78.33 H: 4.92 P: 0.0% not detectable

### Example 15

Poly(1,4-phenylene-oxo-1,4-phenylene-[1-(4-fluorophenyl)-1,2-vinylene]-2,5-dimethoxy-1,4-phenylene-[2-(4-fluorophenyl)-1,2-vinylene])

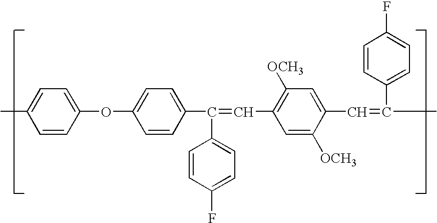

| | | |
|---|---|---|
| 1,4-Bis(4-fluorobenzoyl)diphenyl | 4.144 g | (10 mmol) |
| ether | | |
| 2,5-Dimethoxy-p-xylylene-bis(di- | 4.384 g | (10.3 mmol) |
| ethyl phosphonate) | | |
| Potassium tert-butylate | 3.6 g | (32 mmol) |

The diketone and the diphosphonate are dissolved in about 100 to 150 ml of toluene freshly distilled off from Na/benzophenone in a dry 500 ml multi-necked flask which has a stirrer and reflux condenser and is flushed with argon, the reaction mixture being heated to 100 to 110° C. Potassium tert-butylate is added, during which the reaction mixture foams and becomes dark orange in color. After the addition of the potassium tert-butylate, the mixture is stirred at a bath temperature of 120 to 130° C. for 7 hours. At the end of the reaction time, the batch is hydrolyzed with 100 ml of 10% strength acetic acid. It is left to stand overnight and the phases are then separated. The organic phase is washed once to twice with water and the aqueous phase is extracted by stirring several times with tolune. The organic phases are then combined and concentrated to dryness on a rotary evaporator. The residue is taken up in 250 to 300 ml of benzene and the mixture is boiled for one day, using a water separator. The solution is then filtered off from the residue which remains and is concentrated to 20-30 ml. on a rotary evaporator until the solution can be precipitated in 400 ml of methanol. The luminous yellow precipitate is filtered off with suction and, after extraction with methanol, dried in vacuo at 120° C. 2.7 g (50%) of crude polymer are obtained.

The glass transition point is 187° C. The polymer is soluble in methylene chloride, toluene and tetrahydrofuran.

| | |
|---|---|
| Mₙ (VPO): | 12,260 g mol⁻¹ |
| Mₙ (GPC): | 6,030 g mol⁻¹ |
| M_{w} (GPC): | 146,000 g mol⁻¹ |

C₃₈H₂₆F₂O₃[544.571 calculated: C: 79.39 H: 4.81

found: C: 77.22 H: 5.10 P: 0.0% not detectable

### Example 16

Poly(naphthalene-2,6-diyl[1-phenyl-1,2-vinyl]-2,5-dimethoxy-1,4-phenylene-[2-phenyl-1,2-vinylene])

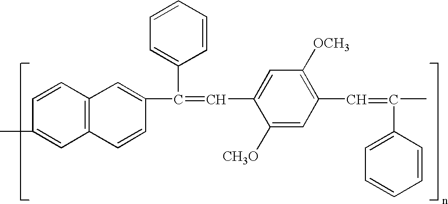

The preparation is as in Example 14.

Mₙ[VPO]: 5,900; T_{g}: 198° C.

### Example 17

Poly(naphthalene-2,6-diyl[1-(4-fluorophenyl)-1,2-vinylene])-2,5-dimethoxy-1,4-phenylene[2,4-fluorophenyl-1,2-vinylene])

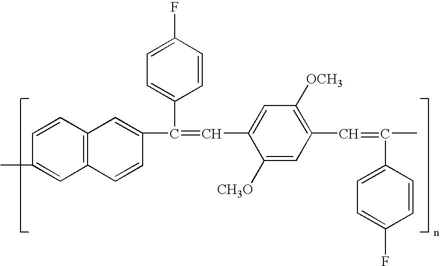

Preparation is as in Example 14.

Mₙ (VPO): 8,000; T_{g}: 167° C.

### Example 18

Poly(thianthrene-2,7-diyl[1-phenyl-1,2-vinylene]-2,5-dimethoxy-1,4-phenylene[2-phenyl-1,2-vinylene])

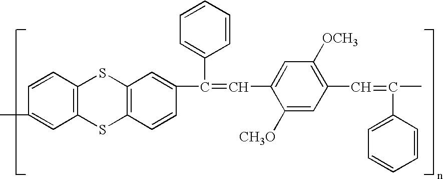

Preparation is as in Example 14.

Mn (GPC): 5,600; M_{w} (GPC): 9,080; T_{g}: 159° C.

### Example 19

Poly(pyridine-2,5-diyl)[1-(4-fluorophenyl)-1,2-vinylene]-2,5-dimethoxy-1,4-phenylene[2-(4-fluorophenyl)-1,2-vinylene])

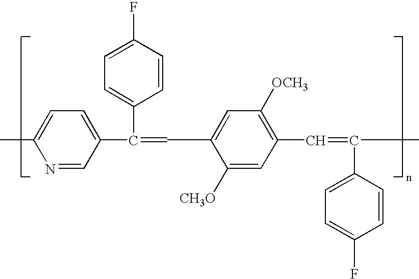

Preparation is as in Example 14.

Mₙ (GPC): 5,300;

λₘₐₓ: 416 nm; 1 g εₘₐₓ: 4.28

λ_{01, max}: 496 nm

C. Electroluminescence Properties

Fluorescence quantum yields and oxidation potentials of polymers according to the invention are listed in Table 1.

TABLE 1

| Polymer according | | |
|---|---|---|
| to Example | &Ovalsolid;_{PL} ¹⁾ | E^{0x1 2)} |
| 3 | 46% | 1.05 |
| 4 | 56% | 1.12 |
| 9 | 49% | 1.26 |
| 11 | 54% | 1.26 |
| 12 | 44% | 0.95 |
| 13 | 49% | 1.17 |
| 14 | 54% | 1.07 |
| 15 | 33% | 1.08 |

¹⁾ Fluorescenc quantum yield &Ovalsolid;_{PL} in CHCl₃ solution (see, for example, C. A. Parker, Photoluminescence of Solutions, Elsevier Publ. Comp., Amsterdam, 1968, page 261 et seq.)
²⁾ First oxidation potential, determined by cyclovoltammetry on a Pt electrode against an Ag/AgCl reference in methylene chloride, 0.1 M tetrabutylammonium hexafluorophosphate

Electroluminescence Device

A solution of the polymer to be measured in chloroform in a concentration of 15 mg/ml is applied by spin-coating at 1000 rpm under nitrogen to a glass carrier (structured, strips 2 mm wide) coated with ITO (indium/tin oxide). The glass carrier is transferred to a high vacuum vapor deposition unit via a sluice, the inert gas atmosphere being retained. Ca strips (2 mm wide, 230 nm thick) are vapor-deposited on the polymer layer at right angles to the ITO strips under 2×10⁻⁵ mbar, using a mask. The device thus obtained, ITO/polymer/Ca, is placed in a sample holder and the electrodes are connected to a current source via spring contacts, one ITO strip being polarized positively and one Ca strip being polarized negatively. When a sufficiently high voltage is applied, an electrofluorescence is observed on the corresponding matrix element.

TABLE 2

| Polymer | | U_{d} | I_{d} | Iₚₕ | | | |
|---|---|---|---|---|---|---|---|
| according | Maximum | (maximum | (maximum | (maximum | | | |
| to | efficiency | efficiency) | efficiency) | efficiency) | Uₘₐₓ | I_{d} (Uₘₐₓ) | Iₚₕ (Uₘₐₓ) |
| Example | [%] | [V] | [mA] | [nA] | [V] | [mA] | [nA] |
| 3 | 0.11 | 15.1 | 0.572 | 9.47 | 19.9 | 1.51 | 17.1 |
| 4 | 0.07 | 13.4 | 0.183 | 1.96 | 16.0 | 0.418 | 4.22 |
| 9 | 0.01 | 19.0 | 7.62 | 11.2 | 19.0 | 7.62 | 11.2 |
| 12 | 0.12 | 10.4 | 1.08 | 20.0 | 14.0 | 5.09 | 62.5 |
| 13 | 0.01 | 16.0 | 2.44 | 3.62 | 18.4 | 8.90 | 11.0 |
| 14 | 0.03 | 16.0 | 1.07 | 5.20 | 17.0 | 1.82 | 8.40 |

Notes on Table 2:
1. Maximum efficiency [%] = quantum efficiency: n(photon)/n(electron)
2. U_{d}/V (maximum efficiency) = voltage at maximum efficiency
3. I_{d}/mA (maximum efficiency) = current through the sample at maximum efficiency
4. Iₚₕ/nA (maximum efficiency) = photocurrent of the detecting photodiode at maximum efficiency, estimation of the luminance: 4 × Iₚₕ/nA = L/cdm⁻².
5. Uₘₐₓ/V = maximum voltage applied
6. I_{d}/mA (Uₘₐₓ) = current through the sample at the maximum voltage applied
7. Iₚₕ/nA (Uₘₐₓ) = photocurrent of the detecting photodiode at the maximum voltage applied

A¹, A³: are identical or different and are selected from

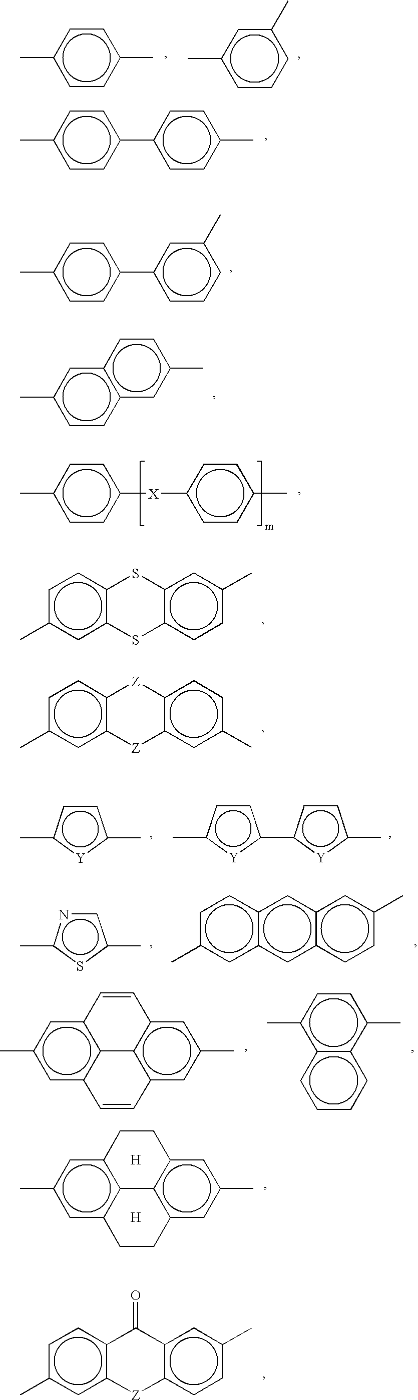

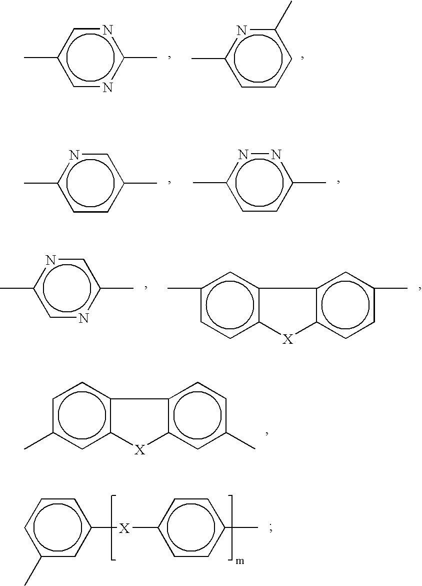

where m=1 to 20,

A²: has the same meanings as A¹ and A³ and is identical to or different from A¹ and A³, of the two possible bonding sites to the polymer, in each case only one being realized;

A¹, A² and A³ can be substituted here independently of one another by one or more radicals R;

X: a single bond, —O—, —S—, —SO—, —SO₂—, —CRR—, —CR═CR—, —CH_{z}—CH_{z}— or —CHR—CHR—;

Y: —O—, —S— or —NR′—;

Z: identical or different —O— or —S—;

R: identical or different at each occurrence and being H or an alkyl group having 1 to 12 carbon atoms, it also being possible for one or two non-adjacent CH₂ groups to be replaced by —O—, —S—, —CO—, —CO—O—, —O—OC— or —Si(CH₃)₂—, —CF₃, -Ph, —O-Ph, —S-Ph, —SO-Ph, —SO₂-Ph, F, Cl, Br, I or —CN;

R′: H, an alkyl group having 1 to 12 carbon atoms or -Ph.

14. The electroluminescent material as claimed in claim 13, wherein the symbols in the formula (I) have the following meanings:
A¹, A³ are identical or different and are selected from 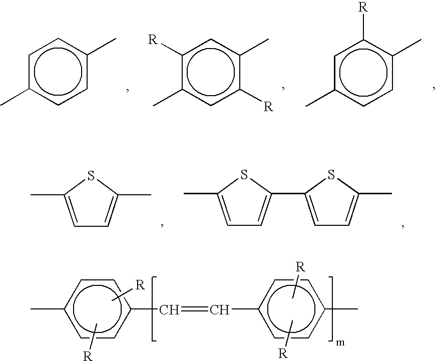
where m=1 to 20, R is H, 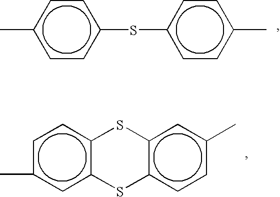
A²: has the same meanings as A¹ and A³ and is identical to or different from A¹ and A³, of the two possible bonding sites 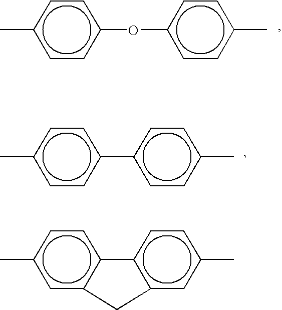
to the polymer, in each case only one being realized, or is.

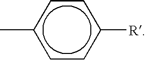

15. The electroluminescent material as claimed in claim 13, wherein the polymer containing structural units of the formula (I) originates from the group (Ia) to (Io) 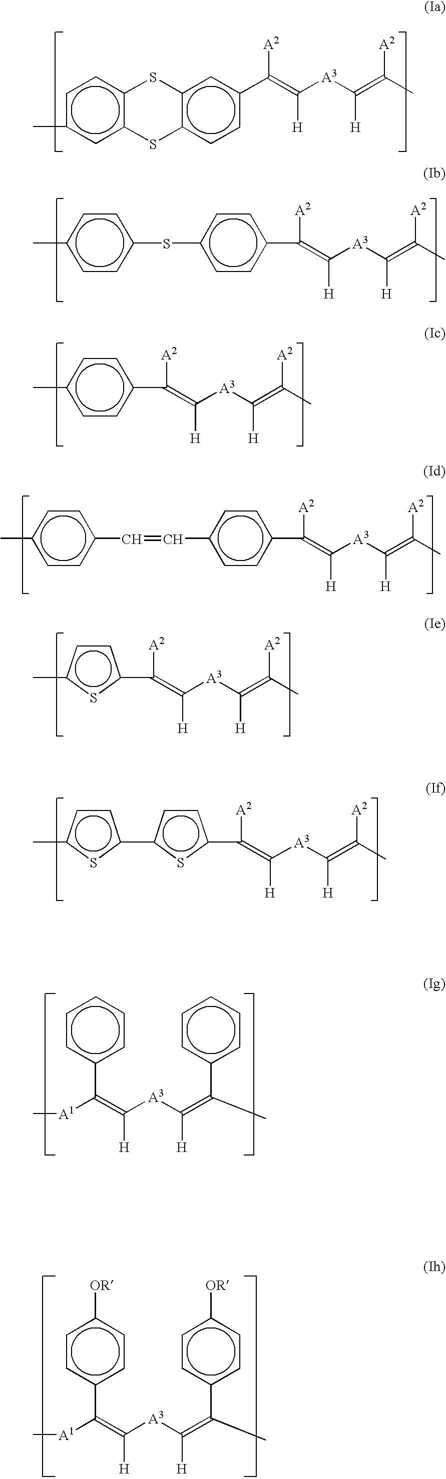 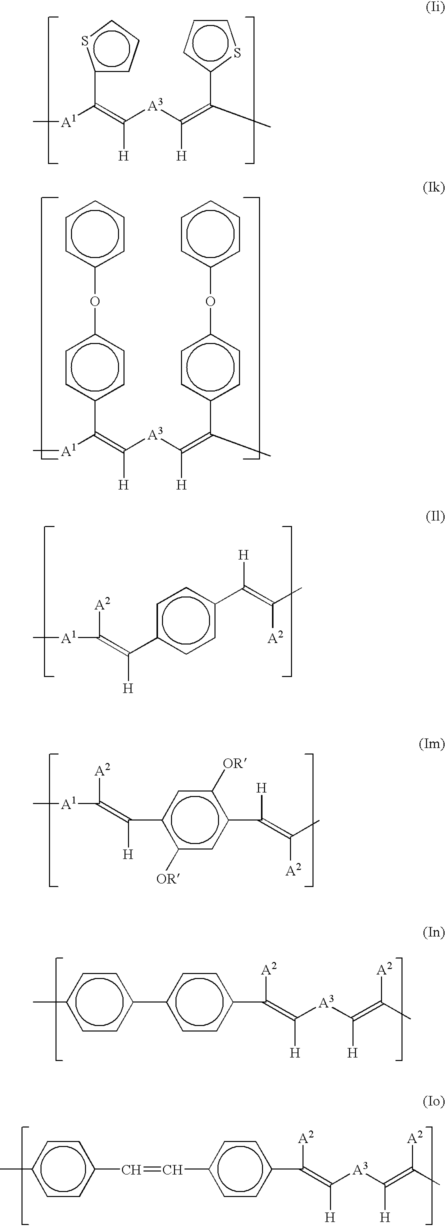
in which A¹, A², A³ and R′ have the meanings given in formula (I).

16. The electroluminescent material as claimed in claim 11, comprising a copolymer containing structural units of the formula (I).

17. An electroluminescent material comprising one or more polymers containing structural units of the formula (I) as claimed in claim 11.

18. A polymer containing structural units of the formula (I)
-[A¹-(A²)C═CH-A³-CH═C(A²)]- (I)
in which A¹, A² and A³ are identical or different mono- and/or polynuclear aryl and/or heteroaryl groups which are optionally linked via one or more bridges, and/or fused and can optionally be substituted, and in which in each case two bonds originate from A¹ and A³ and in each case one bond originates from A², with the proviso that one of the radicals A¹, A² or A³ must be a heterocyclic radical.

19. An electroluminescent device having one or more active layers, wherein at least one of these active layers comprises a polymer as claimed in claim 11 as electroluminescent material.

20. The electroluminescent material as claimed in claim 11 wherein A¹, A², and A³ are linked via one bridge.

21. The electroluminescent material as claimed in claim 13, wherein m is 1, 2 or 13.

22. The electroluminescent material as claimed in claim 13, wherein m is 1.

23. The electroluminescent material as claimed in claim 13, wherein for A³, m>1.

24. The electroluminescent material as claimed in claim 14, wherein m is 1, 2 or 3.

25. The electroluminescent material as claimed in claim 14, wherein m is 1.

26. The electroluminescent material as claimed in claim 14, wherein R is H.

27. The electroluminescent material as claimed in claim 14, wherein for A³, m>1.

28. The electroluminescent material as claimed in claim 27, in which A¹, A² and A³ are linked via one bridge.

29. The electroluminescent material as claimed in claim 28, in which A¹, A² and A³ are linked via one bridge.

30. A process for the production of an electroluminescent material, which comprises
a) subjecting an organophosphorus compound of the formula (III) 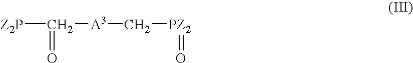
to a condensation reaction with a diketone of the formula (II) 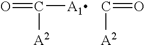
under the action of a basic condensing agent, providing a polymer containing structural units of the formula (I)
-[A¹-(A²)C═CH-A³-CH═C(A²)]- (I)
in which A¹, A² and A³ are identical or different mono- and/or polynuclear aryl and/or hetero-aryl groups which are optionally linked via one or more bridges, and/or condensed and can optionally be substituted, and in which in each case two bonds originate from A¹ and A³ and in each case one bond originates from A²; and
wherein Z is selected from the group consisting of alkoxy and aryl radicals; and
b) applying the resulting polymer to a substrate.
